(19) United States
(12) Patent Application Publication
(10) Pub. No.: US 2003/0191885 A1
(43) Pub. Date: Oct. 9, 2003

(54) On-chip cache redundancy technique

(76) Inventors: Chandra Thimmanagari, Fremont, CA (US); Jui-Cheng Su, Cupertino, CA (US)

Correspondence Address: ROSENTHAL & OSHA L.L.P. / SUN, 1221 MCKINNEY, SUITE 2800, HOUSTON, TX, 77010, US

(21) Appl. No.: 10/119,270

(22) Filed: Apr. 9, 2002

(51) Int. Cl. G06F 12/08

(52) U.S. Cl. 711/3; 711/128

(57) ABSTRACT

A technique for operating a cache memory in one of multiple modes is provided. The technique involves using an fuse dependent control stage to control the generation of read and write enable signals to redundantly implemented tag and data arrays such that a portion of the cache memory may be effectively used even if another portion of the cache memory is defective due to malfunction, yield issues, process variations, etc.

### BACKGROUND OF INVENTION

Referring to FIG. 1, a typical computer system (10) includes, among other things, a microprocessor (12), a system, or “main,” memory (14), and peripheral devices (not shown) such as keyboards, displays, disk drives, etc. The microprocessor (12) includes a central processing unit (“CPU”) (16), which includes, among other things, an arithmetic logic unit (“ALU”) (18), and on-board, or level 1 (“L1”) cache memory (20). When the CPU (16) needs particular data stored in memory, the CPU (16) first searches for the requested data in the L1 cache memory (20). If this search results in a “miss,” i.e., an unsuccessful cache access attempt, a memory controller (22) directs the search for the requested data to occur in level 2 (“L2”) cache memory (24). If this search also results in a “miss,” the memory controller (22) directs the search for the requested data to occur in the system memory (14). Alternatively, if any of the searches in the cache memories (20, 24) result in a “hit,” i.e., a successful cache access attempt, the requested data is made available to the CPU (16) without wasting valuable time that would have otherwise been needed were successive forms of memory required to be searched for the requested data.

The implementation of the various forms of memory shown in FIG. 1 form a memory hierarchy, which is needed because technology does not permit memories that are cheap, large, and fast. By recognizing the nonrandom nature of memory requests, it is possible to implement a hierarchical memory system, as shown in FIG. 2, that performs relatively well. To this end, when attempting to obtain requested data, smaller, faster forms of memory are searched before larger, slower forms of memory are searched. At the top of the memory hierarchy are CPU registers (30), which are small and extremely fast. The next level down in the hierarchy is the special, high-speed memory known as “cache memory” (32). As shown in FIG. 1, cache memory may be divided into multiple distinct levels. Levels of cache memory may be on a CPU, on the same microprocessor on which a particular CPU is located, or be entirely separate from the microprocessor. Below the cache memory (32) is the main memory (34). Main memory (34) is slower and denser than cache memory (32). Below the main memory (34) is virtual memory (36), which is generally stored on magnetic or optical disk. Accessing the virtual memory (36) can be tens of thousands times slower than accessing the main memory (34) because virtual memory searches involve moving mechanical parts. Thus, it is evident that as memory requests do deeper into the memory hierarchy, the requests encounter forms of memory that are larger (in terms of capacity) and slower than higher levels (moving left to right in FIG. 2).

The basic unit of construction of a form of memory is a “module” or “bank.” A memory bank, constructed from several memory chips, can service a single request at a time. With respect to cache memories, the hit rate, i.e., the percentage of successful cache access attempts with respect to all cache access attempts, depends on how such memory banks are implemented within a particular form of memory. In other words, the hit rate depends on the caching scheme or policy employed by a computer system.

Two such caching schemes are “direct-mapped” and “n-way set associative.” In a direct-mapped cache, each memory location in main memory is mapped to a single cache line that it shares with many other memory locations in main memory. Only one of the many addresses that share a particular cache line can use the cache line at a given time. Using such a cache, the circuitry needed to check for hits is fast and relatively easy to design, but the hit rate is relatively poor compared to other memory schemes.

In an n-way set associative cache, the cache is broken into sets of n lines each, and any memory address can be cached in any of those n lines. In other words, the cache buffers data at n different points within the cache memory. Because data can be found at multiple different memory locations, a memory controller does not need to expend precious CPU overhead for address searching the entire cache memory before the requested data can be found.

Generally, a set associative caching policy provides a higher hit rate than a direct-mapped caching policy. However, for some computer applications, a direct-mapped caching policy may provide better system performance due to faster access times. This depends on the address sequenced used by the application, the allocation of memory pages to an application by the operating system, and whether virtual or physical addresses are used for addressing the cache.

FIG. 3a shows an example of a typical direct-mapped cache memory (40). In FIG. 3a, a portion of main memory (14) is stored or cached in the cache memory (40) having a tag array (42) and a data array (44). The tag array (42) and the data array (44) may be a single cache memory logically partitioned into two parts, or two actual, physical cache memories. In general, the tag array (42) stores the physical address of the locations in main memory (14) being cached, and the data array (44) stores the data residing in those respective locations. Both the tag array (42) and the data array (44) share a common index that is used to reference the two arrays.

In operation, the CPU requests data by issuing to a memory controller an address that includes an index component and a tag component. The memory controller then goes to the tag array (42) of the cache memory (40) and checks the specified index to see if that particular tag entry matches the specified tag. If yes, a hit has occurred, and the data corresponding to the specified index is retrieved and provided to the CPU. If no, the requested data has to be retrieved from a lower level cache memory (not shown) or from the main memory (14) itself. For example, an address having an index component of ‘0’ and a tag component of ‘32’ will result in a hit, and data ‘A’ will be retrieved and sent to the CPU. However, there can only be one tag entry per index number and, therefore, a subsequent index component of ‘0’ and a tag component of ‘24’ will result in a miss. A set associative caching scheme generally has a higher hit rate per access, as will be explained below.

FIG. 3b shows an example of a typical 4-way set associative cache memory (50). As in the previous example, the cache (50) is partitioned into a tag array (52) and a data array (54), with both parts sharing a common index. However, instead of a single entry per index, the tag array (52) and the data array (54) each have four entries, shown in FIG. 3b as rows and columns. A row of entries is called a “set” so that there are as many sets as there are index numbers, and a column of entries is called a “way” so that there are four ways for each index number. Those skilled in the art will note that, other than 4-way set associative cache memories, typical set associative caching policies used include 2-way and 8-way set associative cache memories.

In operation, when the memory controller goes to search the tag array (52) at the specified index number, all four ways are compared to the specified tag component. If one of the four ways matches, i.e., a hit occurs, the corresponding way of the corresponding set in the data array (54) is sent to the CPU. Thus, in the previous example, a virtual address having an index component of ‘0’ and tag component of ‘24’ will be a hit because there are four tag entries per index number. If the first tag entry does not match, there are three more chances to find a match per memory access attempt. Thus, effectively, the 4-way set associative caching policy allows the CPU to find cached data one of four ways.

One significant issue involving the production of memory circuits like the ones described above relates to the issue of yield, which is defined as the average ratio of the number of usable devices that pass manufacturing tests to the total number of potentially usable devices. The addition of cache memories to microprocessors, although creating a more powerful microprocessor that is well adapted to memory intensive applications, has the attendant consequence of larger die sizes and poor yields. In fact, a significant amount of memory devices have to be discarded due to manufacturing defects and/or undesired process variations resulting from the manufacturing process. One of the primary causes of device failure/defects is the growth of memory as a percentage of a microprocessor's area. Increased amounts of memory on the microprocessor leads to increased layers, more complicated manufacturing processes, and increased cell densities. Further, because of their high cell density, memories are more prone to defects that already exist in silicon than any other component on a microprocessor.

To combat the adverse effects of poor yield, designers have developed techniques to repair defective devices using expensive external test and repair equipment. Designers have also included extra rows and columns within memory, an implementation known as “redundancy logic.” Including extra rows and columns that can be interchanged with defective elements may, in some instances, help raise memory yield. However, one problem with redundancy models is that as the size and complexity of the microprocessor continue to grow, adding extra rows and columns will become more burdensome, adding to the cost and intricacy of memories and microprocessors. As memory becomes a larger percentage of a microprocessor, redundancy becomes less effective, substantially eroding typical yield gains.

In addition to the challenges that extra rows and columns involve, redundancy improvements also require a costly investment in external test equipment. Designers need extra training and support to find and fix defects, notwithstanding the slowdown in time-to-market measures. In sum, as memory continues to grow as a percentage of the microprocessor's functionality, redundancy begins to lose its appeal as a viable solution due to the mounting cost for equipment, the extra logic required, and the increasing time lag and design hours needed to find, fix, and test defects.

### SUMMARY OF INVENTION

According to one aspect of the present invention, an integrated circuit comprises a cache memory comprising a tag array and a data array, a control stage, first circuitry (responsive to the control stage) that generates signals to the tag array, and second circuitry (responsive to the control stage) that generates signals to the data array, where the control stage determines whether the cache memory operates in any one of a first mode and a second mode, where operation in the first mode allows use of a full address space of the cache memory, and where operation in the second mode allows use of a portion of the full address space of the cache memory.

According to another aspect, a cache memory configurable by a fuse dependent control stage comprises a tag array responsive to first circuitry dependent on the fuse dependent control stage and a data array responsive to second circuitry dependent on the fuse dependent control stage, where the fuse dependent control stage determines whether the cache memory operates in one of a first mode and second mode, where operation in the first mode allows use of a full address space of the cache memory, and where operation in second mode allows use of a portion of the full address space of the cache memory.

According to another aspect, an integrated circuit comprises: memory means for storing data, where the memory means is capable of operating in any one of a first mode and a second mode; generating means for generating read and write enable signals to the memory means; and control means for determining a mode of operation for the memory means, where the generating means is responsive to the control means.

According to another aspect, a method for performing cache memory operations comprises determining whether to operate a cache memory in any one of a first mode and second mode, selectively controlling a state of circuitry based on the determination, generating control signals to the a array dependent on the state of the circuitry, and generating control signals to a data array dependent on the state of the circuitry, where operation in the first mode allows use of a full address space of the cache memory, and where operation in the second mode allows use of a portion of the full address space of the cache memory.

Other aspects and advantages of the invention will be apparent from the following description and the appended claims.

### BRIEF DESCRIPTION OF DRAWINGS

FIG. 1 shows a typical computer system.

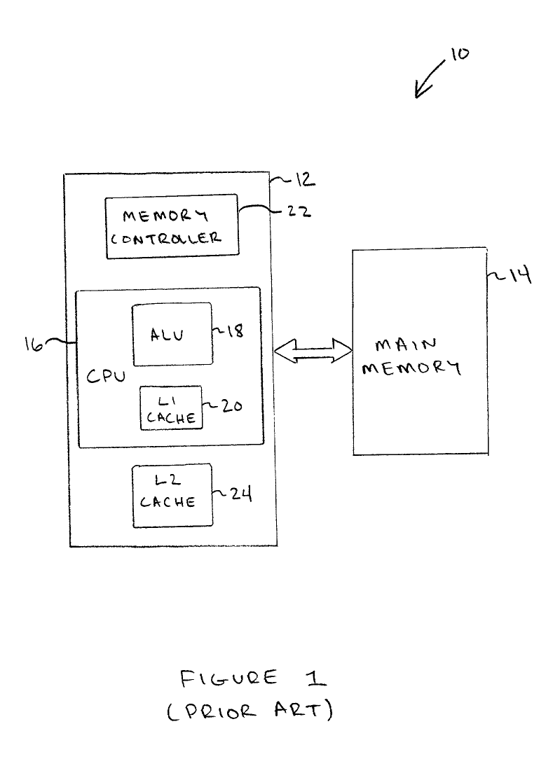

FIG. 2 shows a memory hierarchy of a typical computer system.

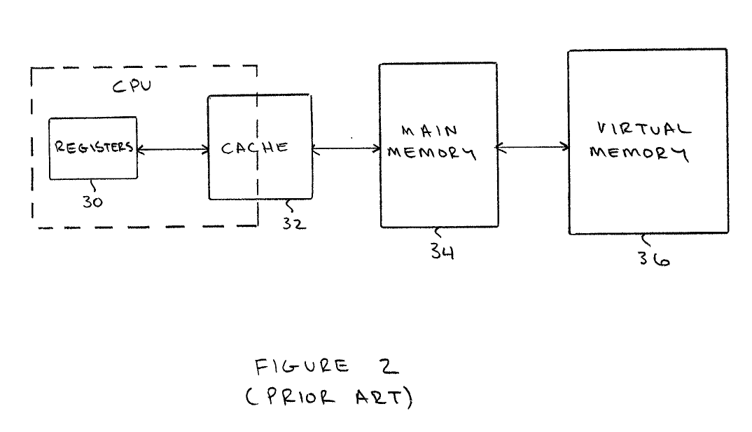

FIG. 3a shows a typical direct mapped cache.

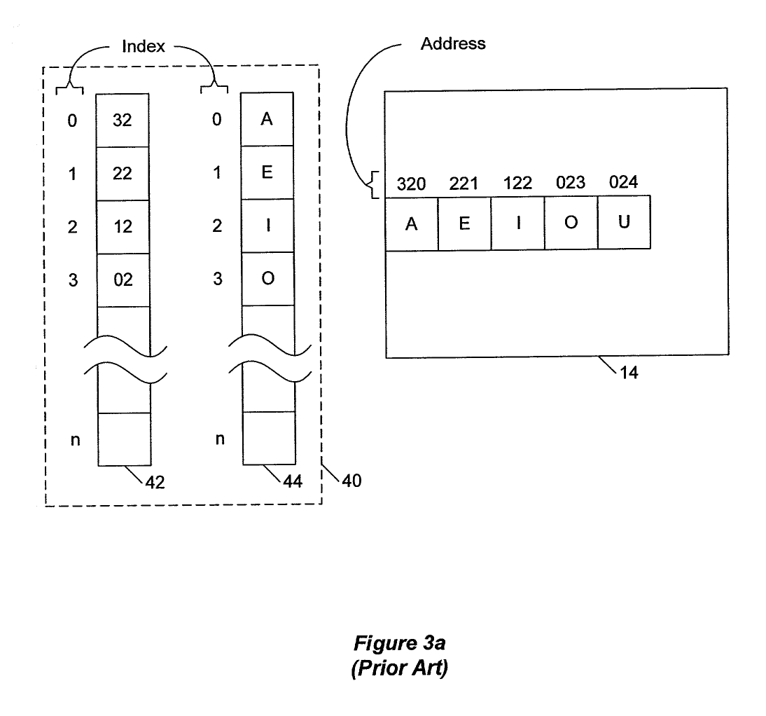

FIG. 3b shows a typical set associative cache.

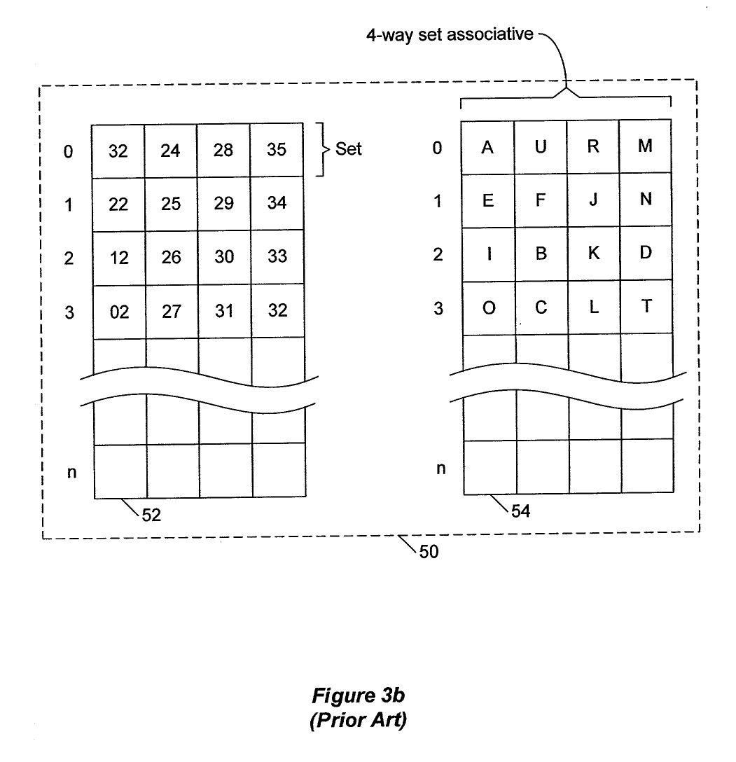

FIG. 4 shows a cache in accordance with an embodiment of the present invention.

FIG. 5a shows a portion of a cache in accordance with an embodiment of the present invention.

FIGS. 5b, 5c, and 5d show circuit logic in accordance with the embodiment shown in FIG. 5a.

FIG. 6a shows a portion of a cache in accordance with an embodiment of the present invention.

FIGS. 6b and 6c show circuit logic in accordance with the embodiment shown in FIG. 6a.

FIG. 7a shows a portion of a cache in accordance with an embodiment of the present invention.

FIGS. 7b, 7c, and 7d show circuit logic in accordance with the embodiment shown in FIG. 7a.

FIG. 8 shows a circuit schematic of a fuse dependent control stage in accordance with an embodiment of the present invention.

### DETAILED DESCRIPTION

Embodiments of the present invention relate to a cache memory design that is controllable to operate in multiple modes. Embodiments of the present invention further relate to a technique for using a cache memory such that a mode of operation of the cache memory may be changed if and when particular elements within the cache memory are not working properly. Embodiments of the present invention further relate to a cache memory that is dependent on a fuse dependent control stage and is capable of properly and adequately functioning by using a portion of the cache memory that is distinct from another portion of the cache memory in which particular elements are not properly working.

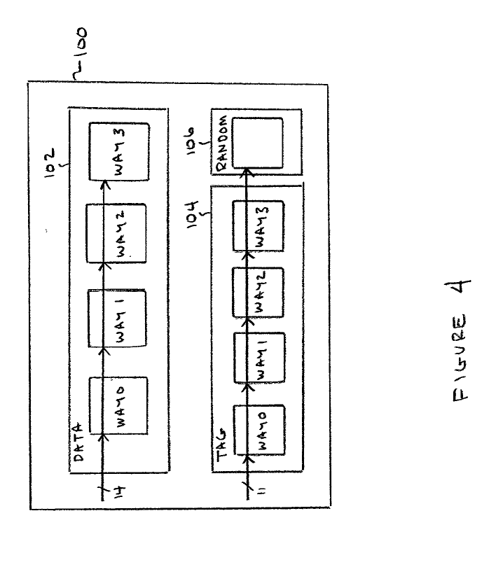

FIG. 4 shows an exemplary cache memory (100) that is used to describe the various embodiments of the present invention. The cache memory (100) shown in FIG. 4 is a 512 KB 4-way set associative cache memory having 64B cache lines. However, although, for purposes of uniformity and simplicity, the cache memory specifications of the cache memory (100) shown in FIG. 4 are used to describe the various embodiments of the present invention, those skilled in the art will understand that the principles of the present invention are equally applicable to other cache memory implementations.

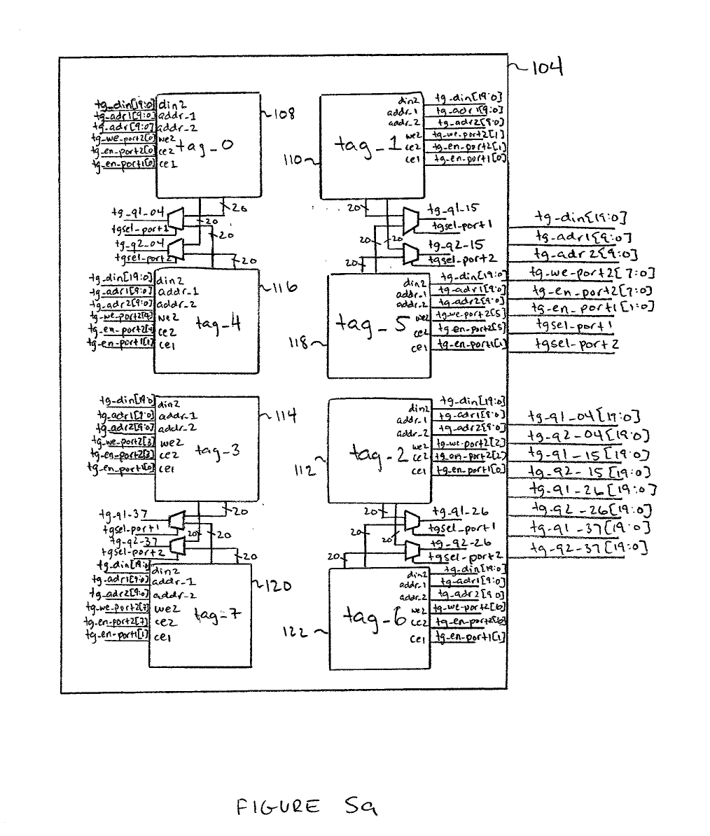

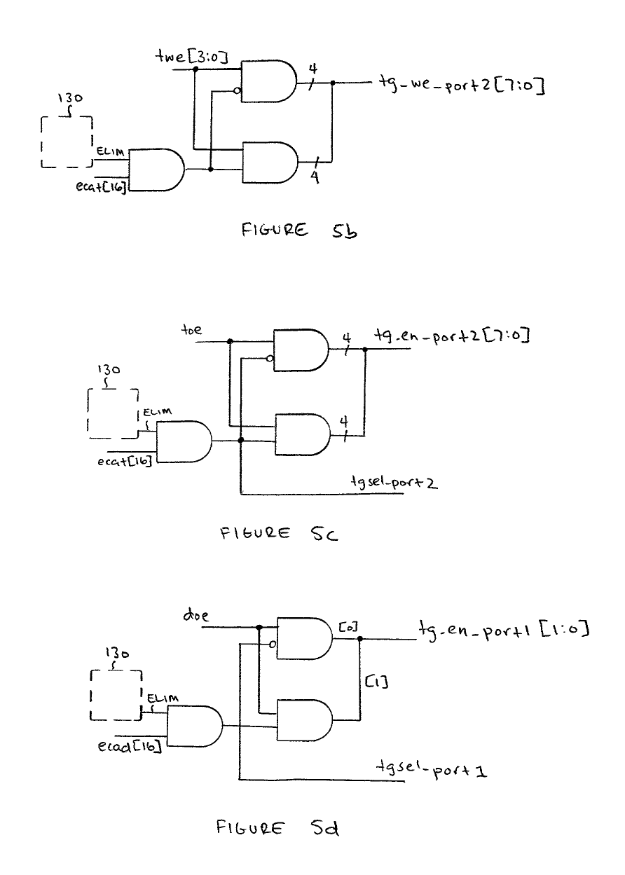

In FIG. 4, the exemplary cache memory (100) is constructed using a data array (102), a tag array (104), and a random array (106). The data array (102) is indexed using 14 bits and the tag array (104) is indexed using 11 bits. Using this implementation of index bits, read and write enables for the data, tag, and random arrays (102, 104, 106) are generated such that the cache memory (100) may be operated in multiple modes. Specifically, the implementation of the cache memory (100) shown in FIG. 4, as will be shown below with reference to FIGS. 5a-d, 6a-c, 7a-d, and 8, allows for the cache memory (100) to operate in both 512 KB and 256 KB modes.

FIG. 5a shows an implementation of the tag array (104) in the cache memory (100), where the tag array (104) incorporates redundancy logic. Inputs to the tag array (104) include a tag data-in bus (tg_din[19:0]), a tag address bus (tg_adr1[9:0] and tg_adr2[9:0]), a tag write enable bus to a second port (tg_we_port2[7:0]), a tag read enable bus to a first port (tg_en_port1[1:0]), a tag read enable bus to the second port (tg_en_port2[7:0]), a tag select signal to the first port (tgsel_port1), and a tag select signal to the second port (tgsel_port2). Outputs from the tag array (104) include pairs of redundant output buses (tg_q1_{—}04[19:0] and tg_q2_{—}04[19:0], tg_q1_{—}15[19:0] and tg_q2_{—}15[19:0], tg_q1_{—}26[19:0] and tg_q2_{—}26[19:0], and tg_q1_{—}37[19:0] and tg_q2_{—}37[19:0]).

The tag array (104) is constructed using memory banks 0 . . . 7 (108, 110, 112, 114, 116, 118, 120, 122). Each tag array bank (108, 110, 112, 114, 116, 118, 120, 122) has a data-in port (din2), first and second tag address ports (addr1, addr2), a write enable port (we2), and first and second read enable ports (ce1, ce2). Based on the inputs to a particular memory bank, the memory bank outputs the contents of a particular cache location addressed by the input at its address ports to multiplexors (124, 126) that have inputs connected to adjacent memory banks. Based on the tag select signals, tgsel_port1 and tgsel_port 2, to the multiplexors (124, 126), contents of a particular location in a selected memory bank is passed to an output of the tag array (104).

The tag array (104) as shown in FIG. 5a is adapted to work in multiple modes due to the dependency of the logic that is used to generate the tag array's inputs on a fuse dependent control stage, which controls in which mode the cache memory (100) operates. To this end, FIGS. 5b, 5c, and 5d show circuit logic used to generate particular inputs to the tag array (104).

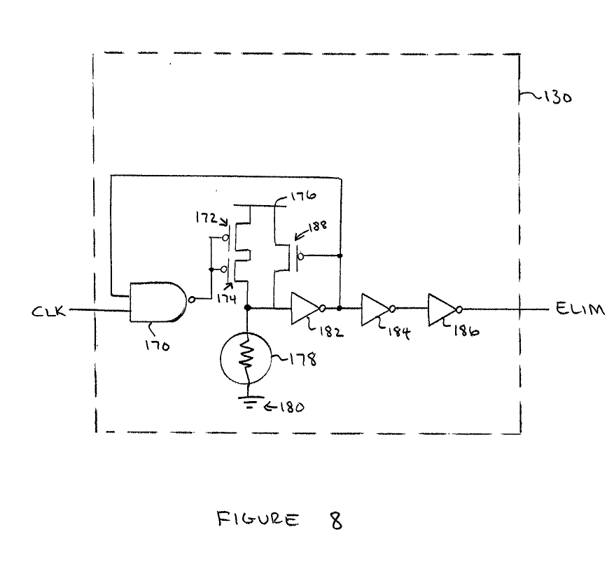

FIG. 5b shows exemplary circuit logic that is used to generate tg_we_port2[7:0]. FIG. 5c shows exemplary circuit logic that is used to generate tg_en_port2[7:0] and tgsel_port2. FIG. 5d shows exemplary circuit logic that is used to generate tg_en_port1[1:0] and tgsel_port1. The circuit logic shown in FIGS. 5b-d is dependent on an output (“ELIM”) of a fuse dependent control stage (130) (discussed in detail with reference to FIG. 8), which outputs ‘0’ when a fuse within the fuse dependent control stage (130) is blown and outputs ‘1’ when the fuse is not blown. The state of the fuse within the fuse dependent control stage (130) signifies which mode the tag array (104) operates.

Table 1 lists a state table of the values of the various signals associated with the tag array (104). Particularly, Table 1 gives the read/write enable values associated for the second port of the tag array (104).

TABLE 1
Tag Array Read/Write Enables for Port2
TAG ARRAY READ

| twe[3:0] | toe | ecat[16] | ELIM | tg_we_port2[7:0] | tg_en_port2[7:0] | tgsel_port2 | banks read from |
|---|---|---|---|---|---|---|---|
| 0000 | 1 | 0 | 1 | 00000000 | 00001111 | 0 | tag_0, tag_1, |
| | | | | | | | tag_2, tag_3 |
| 0000 | 1 | 1 | 1 | 00000000 | 11110000 | 1 | tag_4, tag_5, |
| | | | | | | | tag_6, tag_7 |
| 0000 | 1 | 0 | 0 | 00000000 | 00001111 | 0 | tag_0, tag_1, |
| | | | | | | | tag_2, tag_3 |
| 0000 | 1 | 1 | 0 | 00000000 | 00001111 | 0 | tag_0, tag_1, |
| | | | | | | | tag_2, tag_3 |

TAG ARRAY WRITE

| twe[3:0] | toe | ecat[16] | ELIM | tg_we_port2[7:0] | tg_en_port2[7:0] | tgsel_port2 | banks written to |
|---|---|---|---|---|---|---|---|
| 0001 | 1 | 0 | 1 | 00000001 | 00001111 | 0 | tag_0 |
| 0010 | 1 | 0 | 1 | 00000010 | 00001111 | 0 | tag_1 |
| 0100 | 1 | 0 | 1 | 00000100 | 00001111 | 0 | tag_2 |
| 1000 | 1 | 0 | 1 | 00001000 | 00001111 | 0 | tag_3 |
| 0001 | 1 | 1 | 1 | 00010000 | 11110000 | 1 | tag_4 |
| 0010 | 1 | 1 | 1 | 00100000 | 11110000 | 1 | tag_5 |
| 0100 | 1 | 1 | 1 | 01000000 | 11110000 | 1 | tag_6 |
| 1000 | 1 | 1 | 1 | 10000000 | 11110000 | 1 | tag_7 |
| 0001 | 1 | 0 | 0 | 00000001 | 00001111 | 0 | tag_0 |
| 0010 | 1 | 0 | 0 | 00000010 | 00001111 | 0 | tag_1 |
| 0100 | 1 | 0 | 0 | 00000100 | 00001111 | 0 | tag_2 |
| 1000 | 1 | 0 | 0 | 00001000 | 00001111 | 0 | tag_3 |
| 0001 | 1 | 1 | 0 | 00000001 | 00001111 | 0 | tag_0 |
| 0010 | 1 | 1 | 0 | 00000010 | 00001111 | 0 | tag_1 |
| 0100 | 1 | 1 | 0 | 00000100 | 00001111 | 0 | tag_2 |
| 1000 | 1 | 1 | 0 | 00001000 | 00001111 | 0 | tag_3 |

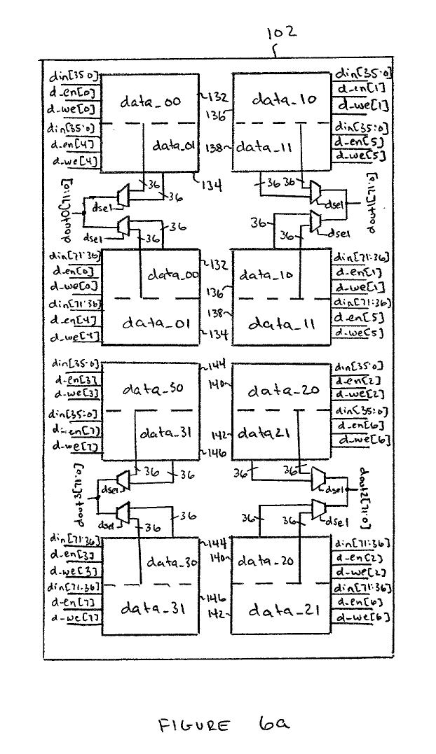

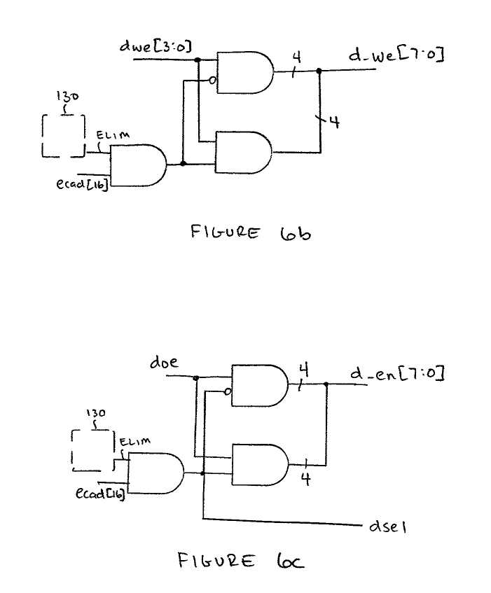

FIG. 6a shows an implementation of the data array (102) in the cache memory (100), where the data array (102) incorporates redundancy logic. Inputs to the data array (102) include a data-in bus (din[35:0] and din[71:36]), a data read enable bus (d en[7:0]), a write enable bus (d we[7:0]), and a data select signal (dse). Outputs from the data array (102) are transmitted on data-out buses (dout( )[71:0], dout1[71:0], dout2[71:0], and dout3[71:0]).

The data array (102) is constructed using memory banks 00, 01, 10, 11, 20, 21, 30, and 31 (132, 134, 136, 138, 140, 142, 144, 146). Each data array bank (132, 134, 136, 138, 140, 142, 144, 146) has a data-in port (din), a write enable port (d_we), and a read enable port (d_en). Based on the inputs to a particular memory bank, the memory bank outputs the contents of a particular cache location addressed by the input at its address ports to multiplexors (148, 150) that have inputs connected to adjacent memory banks. Based on the data select signal, dsel, to the multiplexors (148, 150), contents of a particular location in a selected memory bank is passed to an output of the data array (102).

The data array (102) as shown in FIG. 6a is adapted to work in multiple modes due to the dependency of the logic that is used to generate the data array's inputs on a fuse dependent control stage, which controls in which mode the cache memory (100) operates. To this end, FIGS. 6b and 6c show circuit logic used to generate particular inputs to the data array (102).

FIG. 6b shows exemplary circuit logic that is used to generate d_we[7:0]. FIG. 6c shows exemplary circuit logic that is used to generate d_en[7:0] and dsel. The circuit logic shown in FIGS. 6a and 6b is dependent on an output (“ELIM”) of the fuse dependent control stage (130) (discussed in detail with reference to FIG. 8), which outputs ‘0’ when a fuse within the fuse dependent control stage (130) is blown and outputs ‘1’ when the fuse is not blown. The state of the fuse within the fuse dependent control stage (130) signifies which mode the data array (102) operates.

Table 2 lists a state table of the values of the various signals associated with the data array (102). Particularly, Table 2 gives the read/write enable values of the data array (102).

TABLE 2
Data Array Read/Write Enables
DATA ARRAY READ

| dwe[3:0] | doe | ecad[16] | ELIM | d_we[7:0] | d_en[7:0] | dsel | banks read from |
|---|---|---|---|---|---|---|---|
| 0000 | 1 | 0 | 1 | 00000000 | 00001111 | 0 | data_00, data_10, |
| | | | | | | | data_20, data_30 |
| 0000 | 1 | 1 | 1 | 00000000 | 11110000 | 1 | data_01, data_11, |
| | | | | | | | data_21, data_31 |
| 0000 | 1 | 0 | 0 | 00000000 | 00001111 | 0 | data_00, data_10, |
| | | | | | | | data_20, data_30 |
| 0000 | 1 | 1 | 0 | 00000000 | 00001111 | 0 | data_00 data_10, |
| | | | | | | | data_20, data_30 |

DATA ARRAY WRITE

| dwe[3:0] | doe | ecad[16] | ELIM | d_we[7:0] | d_en[7:0] | dsel | banks written to |
|---|---|---|---|---|---|---|---|
| 0001 | 1 | 0 | 1 | 00000001 | 00001111 | 0 | data_00 |
| 0010 | 1 | 0 | 1 | 00000010 | 00001111 | 0 | data_10 |
| 0100 | 1 | 0 | 1 | 00000100 | 00001111 | 0 | data_20 |
| 1000 | 1 | 0 | 1 | 00001000 | 00001111 | 0 | data_30 |
| 0001 | 1 | 1 | 1 | 00010000 | 11110000 | 1 | data_01 |
| 0010 | 1 | 1 | 1 | 00100000 | 11110000 | 1 | data_11 |
| 0100 | 1 | 1 | 1 | 01000000 | 11110000 | 1 | data_21 |
| 1000 | 1 | 1 | 1 | 10000000 | 11110000 | 1 | data_31 |
| 0001 | 1 | 0 | 0 | 00000001 | 00001111 | 0 | data_00 |
| 0010 | 1 | 0 | 0 | 00000010 | 00001111 | 0 | data_10 |
| 0100 | 1 | 0 | 0 | 00000100 | 00001111 | 0 | data_20 |
| 1000 | 1 | 0 | 0 | 00001000 | 00001111 | 0 | data_30 |
| 0001 | 1 | 1 | 0 | 00000001 | 00001111 | 0 | data_00 |
| 0010 | 1 | 1 | 0 | 00000010 | 00001111 | 0 | data_10 |
| 0100 | 1 | 1 | 0 | 00000100 | 00001111 | 0 | data_20 |
| 1000 | 1 | 1 | 0 | 00001000 | 00001111 | 0 | data_30 |

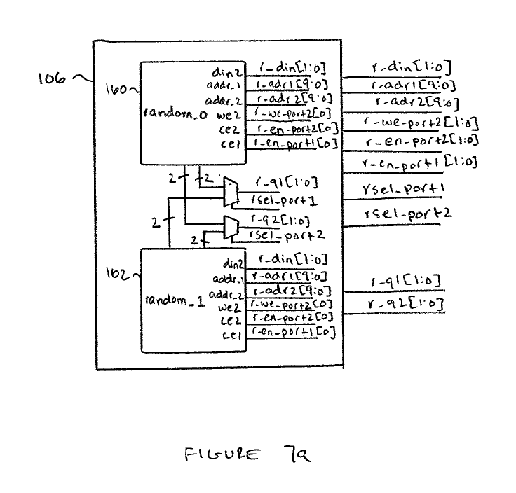

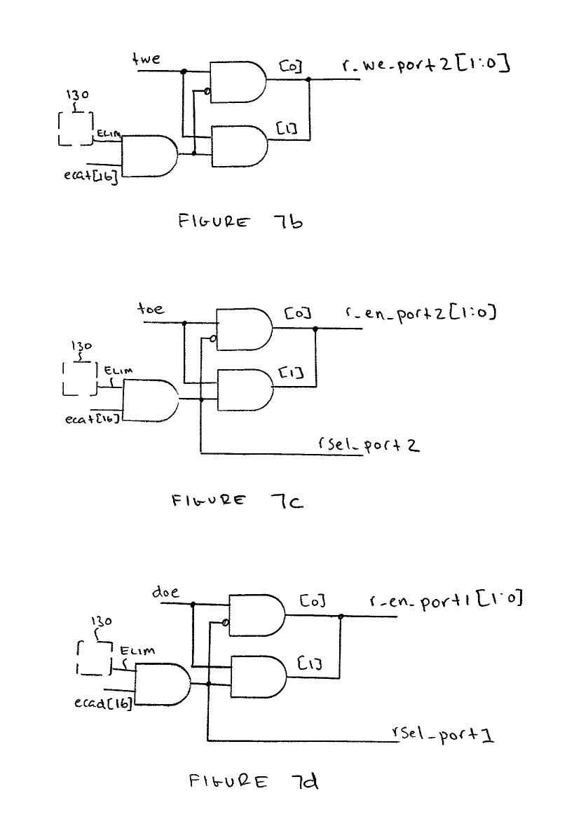

FIG. 7a shows an implementation of the random array (106) in the cache memory (100), where the random array (106) includes redundancy logic. Inputs to the random array (106) include a random data-in bus (r_din[1:0]), a random address bus (r_adr1[9:0] and r_adr2[9:0]), a random write enable bus to a second port (r_we_port2[1:0]), a random read enable bus to a first port (r_en_port1[1:0]), a random read enable bus to the second port (r_en_port2[1:0]), a random select signal to the first port (rsel_port1), and a random select signal to the second port (rsel_port2). Outputs from the random array (106) include redundant output data buses (r_q1[1:0] and r_{—q}2[1:0]).

The random array (106) is constructed using memory banks 0 and 1 (160, 162). Each random array bank (160, 162) has a data-in port (din2), first and second tag address ports (addr1, addr2), a write enable port (we2), and first and second read enable ports (ce1, ce2). Based on the inputs to a particular memory bank, the memory bank outputs the contents of a particular cache location addressed by the input at its address ports to multiplexors (164, 166) that have inputs connected to adjacent memory banks. Based on the random select signals, rsel_port1 and rsel_port 2, to the multiplexors (164, 166), contents of a particular location in a selected memory bank is passed to an output of the random array (106).

The random array (106) as shown in FIG. 7a is adapted to work in multiple modes due to the dependency of the logic that is used to generate the random array's inputs on a fuse dependent control stage, which controls in which mode the cache memory (100) operates. To this end, FIGS. 7b, 7c, and 7d show circuit logic used to generate particular inputs to the random array (106).

FIG. 7b shows exemplary circuit logic that is used to generate r_we_port2[1:0]. FIG. 7c shows exemplary circuit logic that is used to generate r_en_port2[1:0] and rsel_port2. FIG. 7d shows exemplary circuit logic that is used to generate r_en_port1[1:0] and rsel_port1. The circuit logic shown in FIGS. 7b-d is dependent on an output (“ELIM”) of the fuse dependent control stage (130) (discussed in detail with reference to FIG. 8), which outputs ‘0’ when a fuse within the fuse dependent control stage (130) is blown and outputs ‘1’ when the fuse is not blown. The state of the fuse within the fuse dependent control stage (130) signifies which mode the random array (106) operates.

Table 3 lists a state table of the values of the various signals associated with the random array (106). Particularly, Table 3 gives the read/write enable values associated for the second port of the random array (106).

TABLE 3
Random Array Read/Write Enables for Port2
RANDOM ARRAY READ

| Twe | toe | ecat[16] | ELIM | r_we_port2[1:0] | r_en_port2[1:0] | rsel_port2 | banks read from |
|---|---|---|---|---|---|---|---|
| 0 | 1 | 0 | 1 | 00 | 01 | 0 | random_0 |
| 0 | 1 | 1 | 1 | 00 | 10 | 1 | random_1 |
| 0 | 1 | 0 | 0 | 00 | 01 | 0 | random_0 |
| 0 | 1 | 1 | 0 | 00 | 01 | 0 | random_0 |

RANDOM ARRAY WRITE

| Twe | toe | ecat[16] | ELIM | r_we_port2[1:0] | r_en_port2[1:0] | rsel_port2 | banks written to |
|---|---|---|---|---|---|---|---|
| 1 | 1 | 0 | 1 | 01 | 01 | 0 | random_0 |
| 1 | 1 | 1 | 1 | 10 | 10 | 1 | random_1 |
| 1 | 1 | 0 | 0 | 01 | 01 | 0 | random_0 |
| 1 | 1 | 1 | 0 | 01 | 01 | 0 | random_0 |

FIG. 8 shows a circuit schematic of the fuse dependent control stage (130). The fuse dependent control stage (130) is clocked by a clock signal, CLK, which serves as an input to a NAND gate (170). The NAND gate (170) outputs to gates of two PMOS transistors (172, 174) that are connected in series between a supply voltage (176) and a fuse (178), where the fuse (176) has a terminal connected to ground (180). Another terminal of the fuse (176), in addition to being connected to a terminal of one of the two PMOS transistors (172, 174), is connected to an input of an inverter chain (182, 184, 186) and a terminal of a third PMOS transistor (188), which is connected to the supply voltage (176). The output of the first inverter (182), in addition to outputting to the input of the second inverter (184), outputs to a gate terminal of the third PMOS transistor (188) and to an input of the NAND gate (170).

When the fuse (178) is blown, the input to the first inverter (182) is high (due to the connection to the supply voltage (176) through the first and second PMOS transistors (172, 174)), which, in turn, causes the output (“ELIM”) of the fuse dependent control stage (130) to be low. When the fuse (178) is not blown, the input to the first inverter (182) is low (due to the connection to ground (180) through the fuse (178)), which, in turn, causes the output of the fuse dependent control stage (130) to be high. Thus, based on the state of the fuse (178), a particular mode for the cache memory (100) is selected, and the output of the fuse dependent control stage (130) determines what signals should be generated to the various components of the cache memory (100) in that particular mode. Specifically, with respect to the cache memory (100) shown in FIG. 4 and described further with respect to FIGS. 5a-d, 6a-c, 7a-d, and 8, the cache memory (100) is able to operate in a 512 KB mode and a 256 KB mode.

Thus, as those skilled in the art will appreciate, that in the case that part(s) of a cache memory are defective, a mode of operation of the cache memory may be selected by which cache memory function is preserved.

Further, those skilled in the art will understand that the determination of whether a fuse needs to be blown may be made during fabrication after memory tests have been performed on a particular cache memory.

Advantages of the present invention may include one or more of the following. In some embodiments, because read/write enable signals for a cache memory are generated based on which mode the cache memory is desired to operate in, the cache memory may effectively and properly function in multiple modes.

In some embodiments, because a mode of cache memory operation may be selected in which a portion of the cache memory is used due to another portion of the cache memory having defective elements, a cache memory circuit may be used without requiring expensive and timely repairs or replacement.

In some embodiments, because a cache memory operable in multiple modes does not change the type of memory seen by external components, the cache memory retains properties that allow it to be used by such external components even in the case that the functional mode of the cache memory changes. For example, if a cache memory is originally designed to be 4-way set associative, a change in mode of operation of the cache memory does not affect the 4-way set associability of the cache memory. Thus, the implementation of such cache memory does not require modifications to external components that interact with the cache memory.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An integrated circuit, comprising:
a cache memory comprising a tag array and a data array;
a control stage;
first circuitry, responsive to the control stage, that generates signals to the tag array; and
second circuitry, responsive to the control stage, that generates signals to the data array,
wherein the control stage determines whether the cache memory operates in any one of a first mode and a second mode,
wherein operation in the first mode allows use of a full address space of the cache memory, and
wherein operation in the second mode allows use of a portion of the full address space of the cache memory.

2. The integrated circuit of claim 1, wherein signals generated to the tag array comprise read and write enable signals.

3. The integrated circuit of claim 1, wherein signals generated to the data array comprise read and write enable signals.

4. The integrated circuit of claim 1, wherein the tag array and data array comprise redundancy logic.

5. The integrated circuit of claim 1, wherein an output of the control stage is dependent on an electrical fuse.

6. The integrated circuit of claim 1, wherein the cache memory further comprises:
a random array; and
third circuitry, responsive to the control stage, that generates signals to the random array.

7. The integrated circuit of claim 6, wherein signals generated to the random array comprise read and write enable signals.

8. The integrated circuit of claim 1, wherein the cache memory is set associative.

9. A cache memory configurable by a fuse dependent control stage, the cache memory comprising:
a tag array responsive to first circuitry dependent on the fuse dependent control stage; and
a data array responsive to second circuitry dependent on the fuse dependent control stage,
wherein the fuse dependent control stage determines whether the cache memory operates in one of a first mode and second mode,
wherein operation in the first mode allows use of a full address space of the cache memory, and
wherein operation in second mode allows use of a portion of the full address space of the cache memory.

10. The cache memory of claim 9, wherein signals generated to the tag array comprise read and write enable signals.

11. The cache memory of claim 9, wherein signals generated to the data array comprise read and write enable signals.

12. The cache memory of claim 9, wherein the tag array and data array comprise redundancy logic.

13. The cache memory of claim 9, further comprising:
a random array responsive to third circuitry dependent on the fuse dependent control stage.

14. The cache memory of claim 13, wherein signals generated to the random array comprise read and write enable signals.

15. An integrated circuit, comprising:
memory means for storing data, wherein the memory means is capable of operating in any one of a first mode and a second mode;
generating means for generating read and write enable signals to the memory means; and
control means for determining a mode of operation for the memory means, wherein the generating means is responsive to the control means.

16. A method for performing cache memory operations, comprising:
determining whether to operate a cache memory in any one of a first mode and second mode;
selectively controlling a state of circuitry based on the determination;
generating control signals to the a array dependent on the state of the circuitry; and
generating control signals to a data array dependent on the state of the circuitry,
wherein operation in the first mode allows use of a full address space of the cache memory, and wherein operation in the second mode allows use of a portion of the full address space of the cache memory.

17. The method of claim 16, wherein generating control signals to the tag array comprises:
generating a read enable signal to the tag array; and
generating a write enable signal to the tag array.

18. The method of claim 16, wherein generating control signals to the data array comprises:
generating a read enable signal to the data array; and
generating a write enable signal to the data array.

19. The method of claim 16, the cache memory having a random array, the method further comprising:
generating control signals to the random array dependent on the state of the circuitry.

20. The method of claim 19, wherein generating control signals to the random array comprises:
generating a read enable signal to the random array; and
generating a write enable signal to the random array.

21. The method of claim 16, wherein the circuitry comprises an electrical fuse.
